(19) United States
(12) Patent Application Publication
(10) Pub. No.: US 2021/0154738 A1
(43) Pub. Date: May 27, 2021

(54) GETTER DEVICE FOR SINTERING ADDITIVELY MANUFACTURED PARTS

(71) Applicant: MARKFORGED, INC., Watertown, MA (US)

(72) Inventors: Michelle Ling Chao, Somerville, MA (US); Rick Bryan Woodruff, Somerville, MA (US); Christopher Hoffman, Watertown, MA (US)

(21) Appl. No.: 17/101,410

(22) Filed: Nov. 23, 2020

Related U.S. Application Data
(60) Provisional application No. 62/939,216, filed on Nov. 22, 2019.

(51) Int. Cl. B22F 3/10; B22F 1/00; B33Y 70/00

(52) U.S. Cl. CPC B22F 3/1007; B33Y 10/00; B33Y 70/00; B22F 1/0059

(57) ABSTRACT

A method and system of additively manufacturing parts using a getter device is disclosed. Specifically, provided herein are methods and systems of using a getter device in a sintering atmosphere furnace for consistently and repeatedly sintering additively manufactured machined quality parts, such as, for example, titanium parts.

### CROSS-REFERENCE TO RELATED APPLICATIONS

This application claims priority under 35 U.S.C. § 119(e) to U.S. Provisional Application Ser. No. 62/939,216, titled “Getter Device for Sintering Additively Manufactured Parts” filed Nov. 22, 2019, which is incorporated herein by reference in its entirety for all purposes.

### SUMMARY

In accordance with an aspect, there is provided a method of additive manufacturing. The method may comprise substantially surrounding one or more parts comprising a sinterable material with a getter material. The method may further comprise enclosing the one or more substantially surrounded parts in a sintering furnace. The method may additionally comprise exposing the one or more substantially surrounded parts to a sintering atmosphere.

In some embodiments, the sintering atmosphere may be at a pressure in a range of between about 90 kPa and about 202 kPa. In some embodiments, the sintering atmosphere may be at a positive pressure. In some embodiments, the sintering atmosphere comprises at least an atmospheric concentration of at least one of carbon, nitrogen, oxygen, and sulfur.

In some embodiments, the sinterable material comprises Titanium (Ti). For example, at least some of the sinterable Ti material may be a bound powder.

In some embodiments, the getter material may be selected from the group consisting of aluminum (Al), barium (B a), cerium (Ce), hafnium (Hf), lanthanum (La), magnesium (Mg), molybdenum (Mo), ruthenium (Ru), tantalum (Ta), and Ti. In particular embodiments, the getter material may be Ti. In other embodiments, the getter material may be Mg.

In further embodiments, the method may include a step of heating the one or more substantially surrounded parts to a temperature between 1000 and 1400° C.

In further embodiments, the method may include a step of removing the sintered parts from the sintering furnace.

In some embodiments, the sintered parts may be shiny or sparkly. In some embodiments, the sintered parts may have a mechanical ductility between about 2 and about 20%. In some embodiments, the sintered parts may have an elongation or deformation between about 2 and about 20%. In some embodiments, the sintered parts may have a brittleness or plastic deformation between about 2 and about 20%.

In some embodiments, the getter material may have a thickness of about 0.000005 mm to about 10 mm. In further embodiments, the getter material may include includes at least one of titanium nitride (TiN) and titanium oxide (TiO₂). In some embodiments, the getter material may comprise at least one of a sponge, mesh, plurality of beads, a screen, a foil, a matrix, and a zeolite.

In accordance with another aspect, there is provided an additive manufacturing system. The system may comprise a sintering furnace and a sacrificial getter device. During the sintering process, the sintering furnace may operate under a sintering atmosphere.

In some embodiments, the sintering atmosphere may be at a pressure of about atmospheric pressure. In some embodiments, the sintering atmosphere may be at a positive pressure. In some embodiments, the sintering atmosphere may be at a pressure in a range of between about 90 kPa and about 202 kPa. In some embodiments, the sintering atmosphere comprises at least an atmospheric concentration of at least one of carbon, nitrogen, oxygen, and sulfur.

In some embodiments, wherein the sacrificial getter device substantially surrounds one or more additively manufactured parts.

In some embodiments, the getter device may comprise a material selected from the group consisting of wherein the getter material is selected from the group consisting of: aluminum (Al), barium (B a), cerium (Ce), hafnium (Hf), lanthanum (La), magnesium (Mg), molybdenum (Mo), ruthenium (Ru), tantalum (Ta), and Ti. In particular embodiments, the getter device may comprise Ti. In particular embodiments, the getter device may comprise Mg. In further embodiments, the getter device may include at least one of titanium nitride (TiN) and titanium oxide (TiO₂).

In some embodiments, the getter device may comprise a material having a thickness of about 0.000005 mm to about 10 mm. In some embodiments, the getter device may comprise at least one of a sponge, mesh, plurality of beads, a screen, a foil, a matrix, and a zeolite. In further embodiments, the getter device may comprise a box, such as a box with a hinge. In further embodiments, the getter device may comprise a cover.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates Ti parts formed without a getter material in the sintering furnace;

FIG. 2 illustrates a Ti part formed with a getter material in the sintering furnace that has been bent in a vise;

FIG. 3 illustrates Ti parts formed with and without a getter material in the sintering furnace;

FIG. 4 illustrates a getter device positioned over Ti parts to be sintered, according to one embodiment;

FIG. 5 illustrates a getter device positioned over Ti parts to be sintered, according to one embodiment; and

FIG. 6 illustrates a getter device containing Ti parts to be sintered, according to one embodiment.

### DETAILED DESCRIPTION

The present disclosure provides methods of additively manufacturing parts, including substantially surrounding with a getter material one or more parts including a sinterable material; enclosing the getter material and the one or more parts in a sintering furnace; exposing the furnace to a sintering atmosphere; and sintering to form the manufactured parts. The present disclosure envisions a getter material as any material having a high preference for contaminants.

The present disclosure further provides a getter device that can be successfully employed within a sintering furnace system to manufacture parts in a sintering environment that is at a positive pressure, near atmosphere, or at least without any need for vacuum. The present disclosure specifically provides examples of sintering metals, including titanium for manufacturing parts in a low-cost atmosphere sintering oven without the need for vacuum.

### Sintering of Contamination Sensitive Materials

Some powder materials are highly sensitive to contamination in processing, specifically during a sintering process. When exposed to a contaminated atmosphere and sintered during heating or reducing these materials they may react with one or more contaminants from the contaminated atmosphere. For example, titanium (Ti) parts can be highly sensitive to contamination during sintering processes and can react with elements and compounds containing carbon, nitrogen, oxygen, and sulfur with those present in a sintering atmosphere. A reaction with atmospheric contaminants may affect final part composition and/or quality.

Manufactured Ti parts and titanium alloy parts are useful in various applications, including surgical applications, tools, implants and prostheses, in the aerospace, automotive, and marine industries, and in turbines and turbine components. Ti parts can be manufactured using methods, including, for example metal injection molding (MIM), press and sinter, printing, and binderjet. Each of these standard processes will typically use a sintering furnace to prepare the final Ti inclusive parts.

To maintain a clean sintering environment, that is, one that is free of such contaminants that may affect final part composition and/or quality, most currently available sintering systems will include vacuum pumps, vacuum attachments, and processes for operating under vacuum conditions. However, these vacuum sintering systems are larger, more complex, and more expensive to operate due to the added complexity, which can affect part quality. Indeed, these vacuum sintering systems are often more complicated to operate because they require a tight pressure seal, i.e., the vacuum seal, on the furnace chamber. If a gas leak is present on a seal of the furnace chamber, the leak could pull a surrounding environmental atmosphere through the chamber when placed under vacuum conditions, and thus contaminants present in the pulled atmosphere leak into the system. Contamination associated with even small furnace chamber leaks can react, in particular during operation with system components and parts for processing. The present disclosure encompasses a recognition that sintering systems without a need for vacuum and the reduced complexity that accompanies vacuum systems could benefit at least by higher quality parts and higher throughput systems.

### Additive Manufacturing of Parts

### Quality—Shininess, Ductility, and Hardness

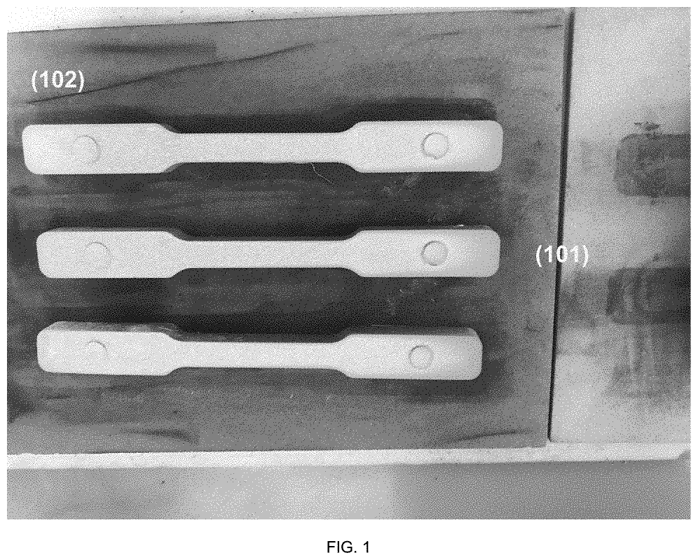

Additively manufactured parts, that is, parts processed without a getter material, exhibited varied low quality when sintered in a near atmosphere pressure sintering environment. Ti parts that were processed without a getter material exhibited a dull finish that was markedly less shiny and/or sparkly when compared with sintered parts that were processed in a vacuum environment. FIG. 1 shows Ti parts without a getter material. The right side (101) exhibits a dull finish, particularly visible along the edges of the right side (101) of the parts.

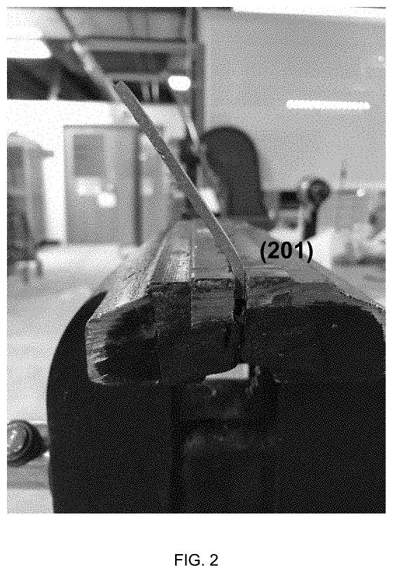

Additively manufactured Ti parts were also subjectively compared with for ductility and brittleness. The quality of the Ti parts that were processed with a getter material exhibited high ductility. FIG. 2 shows a Ti part processed using a getter device and subsequently smoothly bent (201) in a vice. By comparison, when Ti parts sintered without a getter device and/or not under a vacuum atmosphere, these Ti parts did not bend and/or did not bend without exhibiting some damage due to cracking. Additively manufactured Ti parts were also subjectively compared with for brittleness. The quality of the Ti parts that were processed near atmosphere and without a getter material were of substandard quality and exhibited low ductility. When struck with a hammer, the parts formed without a getter material shattered into pieces. By comparison, when Ti parts sintered in a vacuum atmosphere were struck with a hammer, they did not shatter and/or merely exhibited bending of the Ti part.

Varied experiments including using higher purity incoming gas for the sintering environment and/or adding filtering on the incoming gas were performed to improve positive pressure or near atmospheric pressure process sintering. The results of these experiments did not significantly affect the visual appearance (i.e., shininess) or brittleness of the sample parts. The present disclosure encompasses a recognition that additive manufacturing process could benefit from higher throughput sintering systems that operate at atmospheric conditions, either near atmospheric pressure or under positive pressure.

Interestingly, when processing large volumes of parts, a distribution of resultant parts, specifically, a distribution in resultant part quality, was observed within the sintering furnace. Higher quality parts, that is, shinier and/or more sparkly parts, were observed further from the sintering gas inlet. In a larger batch sintering furnace system, a sintering atmosphere gas flow is directional. Chamber geometry, for example, a tube furnace, in combination with a flow control and a directional flow can directionally force a stream of sintering gas past multiple rows of Ti parts arranged therein. Ti parts positioned closer to the sintering gas inlet were dull. Ti parts farther from the sintering gas inlet were shiner. Further, brittleness testing on these parts showed that the shiny parts positioned further from the sintering gas inlet during the sintering processing were also more ductile, that is, more bendable or flexible, when struck with a hammer.

Larger runs with more Ti parts, that is, more sacrificial material volume and surface area, were further performed. Using a standardized test part shape, i.e., a dog bone, mechanical ductility as measured using an applicable ASTM standard showed increased performance. Specifically, Ti dog bones located in downstream positions within the sintering furnace were shinier and exhibited higher ductility. In addition, chemical analysis testing was performed on the materials to establish contamination levels. Improved part purity can be used to create or influence improved thermal uniformity, improved part quality, reduce warping, and/or reduce other sintering related distortions.

Without wishing to be bound to a particular theory, it is believed that as arranged in the sintering system, the Ti parts closer to the gas inlet acted as a sacrificial scrubber purifying the inlet gas. The sintering atmosphere for the parts downstream was thus of at least somewhat higher purity. It is therefore believed that the resultant higher quality parts were exposed to and sintered under the higher purity gas. The present disclosure encompasses a recognition that it is possible to optimize from such a random arrangement of Ti parts to enhance part quality. Advantages of using a sacrificial getter device to react with contaminants in the sintering furnace system include, at least not having to ensure sealing in a furnace chamber, not having to perform vacuum processing, and/or not having to use high purity gases to process and/or produce clean and high-quality parts.

The present disclosure provides a getter device. The present disclosure provides an additive manufacturing system including a getter device for use in consistently and repeatably forming and/or batch processing high quality parts, such as Ti parts. In some embodiments, the present disclosure provides apparatus and methods of additive manufacturing including substantially surrounding Ti parts in a getter device within a sintering furnace operating in a sintering atmosphere at a positive pressure, near atmospheric pressure, or at least above vacuum, such that when present the getter device enables successful and consistent manufacturing of Ti parts.

### Getters, Systems, and Methods

### Getters

### Getter Device Design

In some aspects, getter designs can be in any shape practicable to fit within a sintering furnace. Getter designs can include those which maximize exposed getter surface area substantially surrounding parts without limiting gas flow or inhibiting flow of a sintering gas or without inhibiting access of a sintering atmosphere to parts. The present disclosure encompasses a recognition that getter designs and materials, for example, include a balance between manufacturing cost, manufacturability, and functional lifetime of the materials used.

In some aspects, getter materials substantially surround parts that are to be sintered. In some aspects, substantially surrounding can include shadowing of the one or more parts from an open sintering furnace. Shadowing can for example include blocking or limiting part line of sight from exposed walls of a sintering furnace. An open sintering furnace can include exposed walls, such as for example, in a tube furnace, an inside of the tube. In some aspects, substantially surrounding can between about 20% and about 80% shadowing of the one or more parts from an open sintering furnace. In some aspects, substantially surrounding can between about 40% and about 60% shadowing of the one or more parts from an open sintering furnace. Substantially surrounding can, for example, include: boxes, covers, or other similar structures. Shapes of boxes of such getter devices can include, for example, rectangles, squares, circles, ovals, or any other geometric shape. Shapes of covers of getter devices can include, for example: covers, tents, umbrellas, or any other suitable design.

In some aspects, a getter device, such as a box, can include ventilation. In some aspects, ventilation includes a path for gas (e.g., a sintering atmosphere gas), such one or more holes, one or more slots, or one or more of any suitable opening. In some embodiments, boxes, covers, sides, and other getter devices do not entirely enclose and/or do not seal the Ti parts positioned therein.

In some aspects, a getter device can be designed or engineered as an absorbent. For example, a getter device can be a sponge positioned around a setter plate, which can be positioned at a base of a tube furnace. As a non-limiting example, a getter device can be a plurality of Ti parts positioned around the setter plate. As another non-limiting example, a getter device can be a plurality of Ti beads scattered around the setter plate. As another non-limiting example, a getter device can be a mesh Ti matrix placed on the setter plate. As another non-limiting example, a getter device can be a Ti screen placed on the setter plate. As another non-limiting example, a getter device can be a Ti foil encapsulating one or more parts to be sintered. As another non-limiting example, a getter device can be a zeolite material. As an additional non-limiting example, a getter device can be a mesh Ti matrix placed on the setter plate. In some aspects, a getter device engages into place on a setter place. In some aspects, a getter locks or is secured into place.

In some aspects, the getter device design can be influenced by at least one of a thickness, density, operating flow, and/or concentrations, of a getter material. In some aspects, a getter material thickness can be between about 0.000005 mm and about 10 mm. In some aspects, sintering gas flow is between about 1 standard liters per minute and about 20 standard liters per minute.

In some embodiments, getter device geometries provide a safe enclosure for containing potentially hazardous powder. For example, in certain circumstances, it is envisioned that a sintering process may be stopped prior to completion and there may be a need to open and remove incomplete or unfinished parts. If such removal and handling is required, a getter device can reduce and/or minimize a risk of generating potentially hazardous dust cloud of powder.

### Getter Materials

In some embodiments, a getter material is any material with a high preference for contaminants. In some aspects, a sacrificial getter material, for example, includes Ti. In some aspects, the getter material can include any of the following materials: Ti, aluminum (Al), barium (B a), cerium (Ce), hafnium (Hf), lanthanum (La), magnesium (Mg), molybdenum (Mo), ruthenium (Ru), and tantalum (Ta).

In some aspects, getter materials can be inert and/or non-reactive with furnace materials. For example, in some aspects, the getter material further may include a ceramic, such as titanium nitride (TiN) and/or titanium oxide (TiO₂). In some aspects, getter device designs can include physical separation, e.g., a barrier, positioned between a getter device and a furnace wall to prevent contact or a reaction therebetween. Inert materials and/or barrier layers can be useful, such as to prevent an unfavorable interaction therebetween, for example, such as preventing the formation of a eutectic melt when the walls or other components of a sintering furnace that are composed of iron or steel contact Ti parts within the furnace.

In some aspects, physical separation, for example, including: a bumper, a wrap, a mechanical stop, or other similar structural feature. In some aspects, a getter material can be inert and/or non-reactive with furnace materials. In some aspects, a bumper, a wrap, a mechanical stop, or other similar structural feature includes a material that does not react with stainless steel or Ti, for example, including a ceramic.

### Furnaces

### Furnace Design

Furnace geometries, for example may include a tube furnace, a box, or any other typical furnace shapes. In some embodiments, a furnace may have a geometry that maximizes sintering volume or surface area within the sintering furnace. Furnaces may be capable of heating parts within and beyond desired temperature ranges, for example, temperature ranges including between about room temperature, e.g., about 25° C. and about 1400° C. Furnace walls can react with getter materials such as Ti.

### Furnace Atmosphere

A sintering furnace may operate under a sintering atmosphere, which includes operating pressures that may be at a positive pressure, at atmospheric pressure, or at least above vacuum. A typical sintering furnace sintering atmosphere operating pressure range may be from about 90 kPa to about 220 kPa. Typical sintering furnaces have contaminants, for example, including carbon, nitrogen, oxygen, and sulfur, either introduced from the incoming gas supplied or from the components placed inside the furnace itself such as hydrocarbons from the debinding process or moisture absorbed by any ceramic materials within the furnace.

In some aspects, a sintering furnace sintering atmosphere may be provided, as noted herein, utilizing high purity precursor gases. The present disclosure envisions utilizing such high purity gases for processing and manufacturing high quality contamination sensitive parts. In some aspects, the present disclosure further encompasses a recognition that such high purity gases may not be available. Indeed, the present disclosure encompasses a recognition that sintering furnace operation may be in an environment where background environmental and atmospheric conditions are such that baseline contamination levels are higher than would be in found in a typical laboratory. In particular, the present disclosure envisions that provided sintering systems can successfully operate in the extremes of a particular environment. For example, the present disclosure envisions sintering furnace operation in a cleanroom environment on one extreme or sintering furnace operation in a harsh environment with a remote powered encampment having varied and numerous unknown airborne/gaseous contaminants. Without wishing to be bound to any particular theory, the presently disclosed sintering system, using a sacrificial getter device to react with such contaminants in the sintering furnace system, will produce high quality desirable part. In some aspects, processes include no requirement to ensure sealing in a furnace chamber, no requirement for vacuum processing, and/or no requirement for the use of high purity gases for the sintering atmosphere. In some aspects, getter designs having variable sacrificial surface area, flow dynamics, etc.

### Parts

### Part Materials

Part materials protected by a sacrificial getter material, for example, include sensitive metal feedstock materials including, but not limited to, aluminum, magnesium, stainless steel, e.g., 316L stainless steel, and/or any other sinterable material that may be sensitive to background contamination.

### Part Quality

### Example—Ti

Shininess

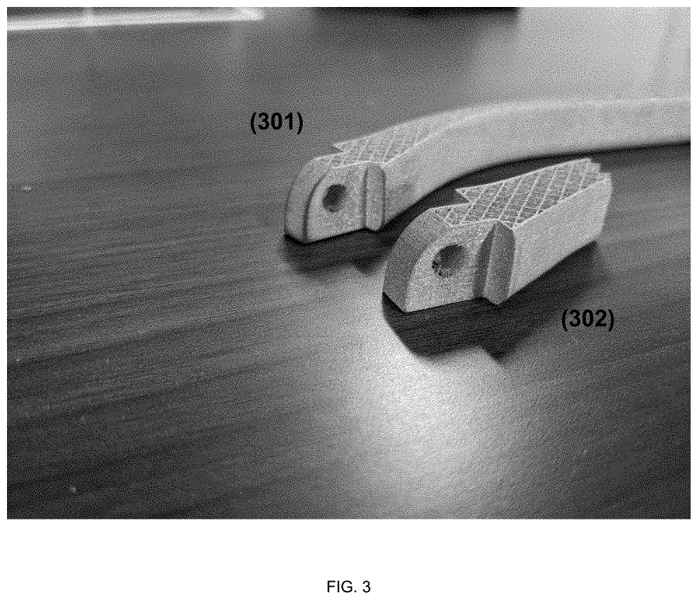

FIG. 3 compares Ti parts. Ti part (301) (rear) was processed without a getter device and exhibits evidence of both dullness and contamination. By comparison, Ti part (302) (front) was processed with a getter device and is shiny and shows no evidence of any edge contamination (i.e., no blackened or charcoal corners).

Brittleness

Table 1 shows a relevant ASTM Standard, ASTM F2885-11 (MIM)—ASTM B348 (wrought) and ASTM F14722 (wrought) for Ti64 grade 5 alloy chemical requirements.

TABLE 1
ASTM F2885-11 standard elemental weight percent for
a Ti alloy approved for surgical implant applications.
ASTM F2885 wt %

| | |
|---|---|
| V | 3.5-4.5 |
| Al | 5.5-6.75 |
| C | 0.08 (max.) |
| O | 0.2 (max.) |
| N | 0.2 (max.) |
| Fe | 0.3 (max.) |

### Experimental Summary

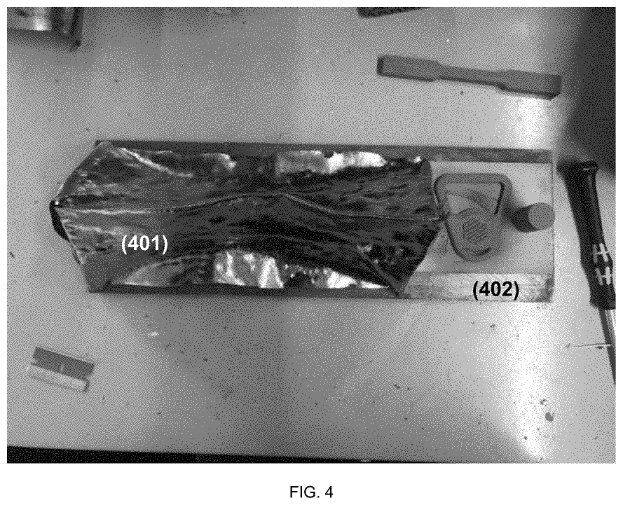

Initial attempts to sinter with a getter device shaped as a Ti tent formed from Ti shim stock Ti which warped on the setter plate. FIG. 4 shows parts (not labeled) covered by a Ti tent (401) on a flat setter plate (402) in accordance with embodiments of the present disclosure.

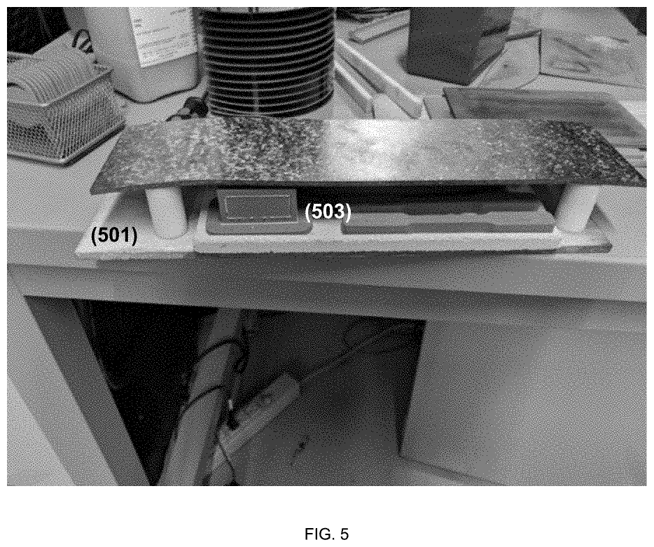

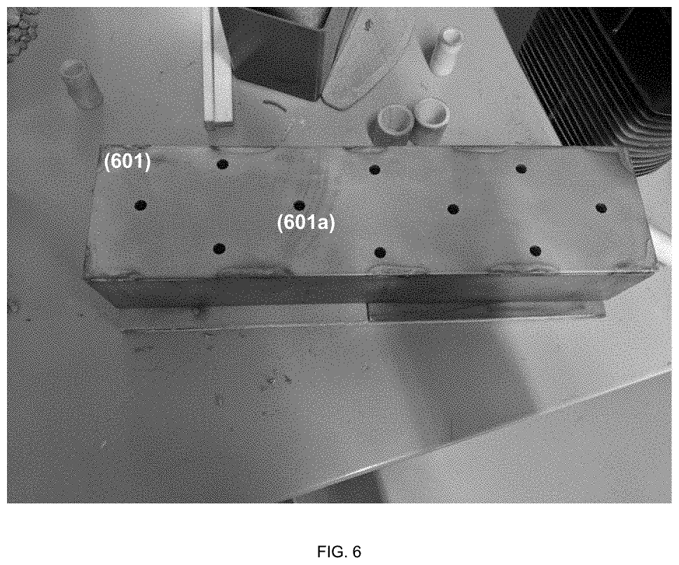

A prototype getter device was made with a Ti sheet metal welded into a 5-sided box and an open side sat on top of a setter with ventilation holes placed throughout the walls. FIG. 5 shows a photo of the open-sided prototype of a getter device (501) containing a plurality of parts (503) therein in accordance with embodiments of the present disclosure. FIG. 6 shows a photo of a substantially enclosed box (601) with a plurality of ventilation holes (601a) in accordance with embodiments of the present disclosure.

Parts sintered using a getter device with this geometry showed mechanical properties and internal microstructure that were good or exceeded as defined above and had the correct chemistry (e.g., had and oxygen content at 0.2% wt. as indicated in Table 1). The getter device geometry illustrated in FIG. 6 has been run successfully twenty times in a furnace with parts still meeting the Ti64 chemical composition requirements of Table 1.

### Analysis

Table 2 (below) shows the effect of atmospheric composition and getter device use on Ti part ductility.

TABLE 2
Effects on atmosphere and getter material on resultant part
physical properties

| Test | | Ultimate Strength | % |
|---|---|---|---|
| Condition | Getter Used | (MPa) | Elongation |
| Vacuum | No | 863 | 8 |
| Sintering | | | |
| Atmosphere | No | 850 | 1 |
| Sintering | | | |
| Atmosphere | Yes | 897 | 12 |
| Sintering | | | |

What is claimed is:

1. A method of additive manufacturing, comprising:
substantially surrounding one or more parts comprising a sinterable material with a getter material;
enclosing the one or more substantially surrounded parts in a sintering furnace; and
exposing the one or more substantially surrounded parts to a sintering atmosphere.

2. The method of claim 1, wherein the sintering atmosphere is at a pressure in a range of between about 90 kPa and about 202 kPa.

3. The method of claim 1, wherein the sintering atmosphere includes a positive pressure.

4. The method of claim 1, wherein the sintering atmosphere comprises at least an atmospheric concentration of at least one of carbon, nitrogen, oxygen, and sulfur.

5. The method of claim 1, wherein the sinterable material comprises Titanium (Ti).

6. The method of claim 5, wherein at least some of the Ti in the sinterable material is a bound powder.

7. The method of claim 1, wherein the getter material is selected from the group consisting of aluminum (Al), barium (B a), cerium (Ce), hafnium (Hf), lanthanum (La), magnesium (Mg), molybdenum (Mo), ruthenium (Ru), tantalum (Ta), and Ti.

8. The method of claim 7, wherein the getter material comprises Ti.

9. The method of claim 7, wherein the getter material comprises Mg.

10. The method of claim 1, further comprising a step of heating the one or more substantially surrounded parts to a temperature between 1000 and 1400° C.

11. The method of claim 10, further comprising a step of removing the sintered parts from the sintering furnace.

12. The method of claim 11, wherein the sintered parts have a mechanical ductility between about 2 and about 20%.

13. The method of claim 11, wherein the parts have an elongation or deformation of between about 2 and about 20%.

14. The method of claim 11, wherein the parts have a brittleness or plastic deformation of between about 2 and about 20%.

15. The method of claim 1, wherein the getter material has a thickness of about 0.000005 mm to about 10 mm.

16. The method of claim 1, wherein the getter material includes at least one of titanium nitride (TiN) and titanium oxide (TiO₂).

17. The method of claim 1, wherein the getter material comprises a sponge.

18. The method of claim 1, wherein the getter material comprises mesh.

19. The method of claim 1, wherein the getter material comprises a plurality of beads.

20. The method of claim 1, wherein the getter material comprises a screen.

21. The method of claim 1, wherein the getter material comprises a foil.

22. The method of claim 1, wherein the getter material comprises a matrix.

23. The method of claim 1, wherein the getter material comprises a zeolite.

24. An additive manufacturing system, comprising:
a sintering furnace; and
a sacrificial getter device,
wherein during a sintering process the sintering furnace operates under a sintering atmosphere.

25. The additive manufacturing system of claim 24, wherein the sintering atmosphere is at a pressure of about atmospheric pressure.

26. The additive manufacturing system of claim 24, wherein the sintering atmosphere includes a positive pressure.

27. The additive manufacturing system of claim 24, wherein the sintering atmosphere is at a pressure in a range of between about 90 kPa and about 202 kPa.

28. The additive manufacturing system of claim 24, wherein the sintering atmosphere comprises at least an atmospheric concentration of at least one of carbon, nitrogen, oxygen, and sulfur.

29. The additive manufacturing system of claim 24, wherein the sacrificial getter device substantially surrounds one or more additively manufactured parts.

30. The additive manufacturing system of claim 24, wherein the getter device comprises a material is selected from the group consisting of wherein the getter material is selected from the group consisting of: aluminum (Al), barium (Ba), cerium (Ce), hafnium (Hf), lanthanum (La), magnesium (Mg), molybdenum (Mo), ruthenium (Ru), tantalum (Ta), and Ti.

31. The additive manufacturing system of claim 24, wherein the getter device comprises Ti.

32. The additive manufacturing system of claim 31, wherein the getter device includes at least one of titanium nitride (TiN) and titanium oxide (TiO₂).

33. The additive manufacturing system of claim 24, wherein the getter device comprises Mg.

34. The additive manufacturing system of claim 24, wherein the getter device comprises a material having a thickness of about 0.000005 mm to about 10 mm.

35. The additive manufacturing system of claim 24, wherein the getter device comprises a sponge.

36. The additive manufacturing system of claim 24, wherein the getter device comprises mesh.

37. The additive manufacturing system of claim 24, wherein the getter device comprises a plurality of beads.

38. The additive manufacturing system of claim 24, wherein the getter device comprises a screen.

39. The additive manufacturing system of claim 30, wherein the getter device comprises a foil.

40. The additive manufacturing system of claim 30, wherein the getter device comprises a matrix.

41. The additive manufacturing system of claim 30, wherein the getter device comprises a zeolite.

42. The additive manufacturing system of claim 30, wherein the getter device comprises a box.

43. The additive manufacturing system of claim 30, wherein the getter device comprises a box with a hinge.

44. The additive manufacturing system of claim 30, wherein the getter device comprises a cover.
